(19) United States
(12) Patent Application Publication
(10) Pub. No.: US 2005/0094749 A1
(43) Pub. Date: May 5, 2005

(54) Non-binary viterbi data processing system and method

(76) Inventors: Cheng-Ting Wu, Sindian City (TW); Hung-Ming Chang, Jhubei City (TW)

Correspondence Address: HOFFMAN WARNICK & D'ALESSANDRO, LLC, 3 E-COMM SQUARE, ALBANY, NY, 12207, US

(21) Appl. No.: 10/980,074

(22) Filed: Nov. 3, 2004

(30) Foreign Application Priority Data
Jul. 11, 2003 (TW) 092131342

(51) Int. Cl. H04L 27/06

(52) U.S. Cl. 375/341

(57) ABSTRACT

The present invention provides a non-binary Viterbi data processing system comprising a non-binary Viterbi processor, a path metric memory, and a memory access device. The non-binary Viterbi processor is used for obtaining the path metrics of a set of states according to a Viterbi decoding procedure. The path metric memory comprises memory units of the same amount as the states. The memory units are depicted by combinations of symbols for storing the corresponding path metrics of the set of states. The memory access device is used for reading out the path metrics from the path metric memory for calculation by the non-binary Viterbi processor, and for writing the updated path metrics back to the path metric memory. Therefore, merely the same amounts of the memory units as the states in the path metric memory are required for update of the set of path metrics.

### BACKGROUND OF THE INVENTION

1. Field of the Invention

The present invention relates to a non-binary Viterbi data processing system and the method thereof.

2. Description of the Prior Art

The Viterbi algorithm has been extensively applied in various apparatuses for decoding data with the convolution code, which is also called the channel code. The prior art utilizes a Viterbi data processing system to decode data with the convolution code in an apparatus. Based on complexity of the convolution code, the Viterbi data processing system is divided into two types, binary and non-binary.

In the binary Viterbi data processing system, every symbol of the received data is either 0 or 1. Data will be encoded bit by bit in the convolution code system of the output end. The non-binary Viterbi data processing system however encodes the data by more than 1 bit. Therefore, instead of only 0 and 1, the encoded data could be symbols of 0˜2ⁱ−1. Here, the index i represents that the convolution code system is encoded by i bits. Currently, the prior art is encoded by 3 bits, providing eight encoded symbols 0˜7. Nevertheless, the binary decoding/encoding system is inadequate for more complicated data transmitted in the current various apparatuses. The non-binary data decoding/encoding system is therefore commonly developed.

In the conventional Viterbi data processing system, since each data symbol is correlated with its preceding and subsequent data symbols, the decoding logic becomes very complicated. That is, while decoding the data symbols, the correlation between the received symbol and the preceding and subsequent symbols must be taken into consideration to further select the most possible decoding value.

Referring to FIG. 1, FIG. 1 is a schematic diagram of the Viterbi data processing system 10 and the symbol registers 13, 15 of the prior art. The data symbols encoding with convolution code received in the conventional apparatus applying the Viterbi data processing system are sequentially stored in the symbol registers 13, 15. Because the convolution code has a temporal correlation, i.e. the decoding of each symbol is correlated with its preceding and subsequent symbols, the best way of decoding is temporarily storing all of the symbols before decoding. However, due to high cost and data processing delay of the symbol registers, two symbol registers are generally installed in the present apparatus to sequentially decode the data.

Referring to FIG. 2, FIG. 2 is a schematic diagram of the Viterbi decoding logic of two symbols of the prior art. The prior art defines two symbols as a state. If it is a binary system, the possible decoding value of the state 00 or 10 is obtained by calculation and comparison from the state 00 or 01. The possible decoding value of the state 01 or 11 is obtained by calculation and comparison from the state 10 or 11. If it is a non-binary encoding system and the symbol is encoded by 3 bits, the symbol states 00, 10, 20, 30, 40, 50, 60, 70 are viewed as a group, and the possible decoding value is obtained by calculation and comparison from the symbol states 00, 01, 02, 03, 04, 05, 06, 07, without further using states in other groups. As mentioned above, the possible decoding values of the symbol states of each of the following groups (01, 11˜71), (02, 12˜72) . . . (07, 17˜77) are also obtained by respectively calculating and comparing the corresponding states of each group (10, 11˜17), (20, 22˜27). . . (70, 71˜77), without further using states in other groups. In other words, in the non-binary Viterbi data processing system, if the symbol is encoded by 3 bits, the system needs to consider the correlation between two symbols, including 64 ((2³)²) states of the received symbols. Since there are 8 possible decoding values of each state, 512 (64×8) decoding calculation procedures are needed.

Referring to FIG. 3, FIG. 3 is a schematic diagram of the Viterbi data processing system 10 of the prior art. The Viterbi data processing system 10 of the prior art comprises a path metric memory 12, a multiplexer 14, a buffer memory 16, a branch metric processor 18, and an add-compare-select (ACS) module 20. When the conventional Viterbi data processing system 10 processes the received symbols, as mentioned above, all possible values of each state need to be calculated to determine the most possible transition value of each state. The prior art determines the most possible transition value by the path metric of each state. The equation for calculating the path metric is as equation 1:
PMₐ(b0)=PM(0a)+BM(b0a) Equation 1:

The above equation 1 is used for calculating all possible path metrics of the latest states. If the symbol of the original state is 0a, i.e. the symbols of the original state temporarily stored in the symbol registers 13, 15 are “0” and “a” (a=0˜7) respectively and the last received encoding symbol is “b”, after the state transition, the original encoded symbol “a” will be erased and the symbols temporarily stored in the symbol registers 13, 15 are respectively updated to be “b” and “0” (b=0˜7), i.e. the symbol of the latest state is b0. If the latest state b0 is generated from the original state 0a through the state transition, the path metric of the latest state b0 can be depicted as PMa(b0); and if the path metric of the latest state b0 is encoded by 3 bits, it will comprise 8 types as PM₀(b0)˜PM₇(b0). The size of the path metric PMₐ(b0) becomes the summation of the path metric PM(0a) of the original state 0a and the branch metric BM(b0a) generated through the state transition.

The path metric memory 12 is used for storing the latest path metrics of each state. Whenever the conventional Viterbi data processing system 10 receives a latest symbol, the system will begin the updating procedure of the path metric memory 12 by the order of 00, 01, 02 . . . 07, 10 . . . 70 . . . 77, so as to sequentially update the latest path metric of each state in the path metric memory 12.

In the following, the prior art is illustrated with the example of updating the path metric of the state 00. When updating the path metric of the state 00, the multiplexer 14 first sequentially reads out all the path metrics of 8 states 00, 01 . . . 07 that could be transformed into the state 00 from the path metric memory 12 and sequentially stores all path metrics of 8 states in the buffer memory 16. The branch metric processor 18 is used for calculating the branch metrics that could be transformed into the state 00 in the buffer memory 16 and for transmitting the calculation result to the ACS module 20.

Referring to FIG. 4, FIG. 4 is a schematic diagram of the ACS module 20 shown in FIG. 3. The ACS module 20 of the prior art comprises an adder 22, a temporary buffer 24, a comparator 26, and a selector 28. The adder 22 is used for adding up the path metrics of possible states stored and the corresponding branch metrics in the buffer memory 16. The temporary buffer 24 is used for temporarily storing the calculation result from the adder 22. The adder 22 continually receives the path metrics of possible states and the corresponding branch metrics transmitted from the buffer memory 16 and then stores the calculation result in the temporary buffer 24. Until all of the 8 possible states have been stored in the temporary buffer 24, the comparator 26 compares the calculation result of all possible states, and then the selector 28 selects the smallest value as the latest path metric of the state 00 and writes it back to the path metric memory 12.

Accordingly, the path metric memory 12 in the conventional Viterbi data processing system 10 requires a lot of space to store data during the data processing procedure. For example, to a system with data encoded by 3 bits and each state comprising two symbols, at least two times the 64 states are required (the preceding and subsequent path metrics) to store all data. However, it is quite a waste of resource that only 64 states will be actually used. Furthermore, in the Viterbi data processing system of the prior art, because the system has to sequentially read out all possible states for calculation, it needs to continually access the path metric memory. Therefore, it also seriously wastes the resources of the apparatus.

### SUMMARY OF THE INVENTION

The objective of the present invention is to provide a non-binary Viterbi data processing system for effectively reducing the required storage capacity in the path metric memory. The other objective of the present invention is to provide a non-binary Viterbi data processing system for reducing memory-accessing frequencies to save system resources.

The non-binary Viterbi data processing system of the present invention comprises a non-binary Viterbi processor, a path metric memory, and a memory access device. The non-binary Viterbi processor is used for obtaining the path metrics of a set of states according to a predetermined Viterbi decoding procedure; during each state transition, a plurality of branch metrics for each set of states are calculated to update the corresponding path metrics of each set of states. The set of states is encoded by the combination of at least two symbols respectively representing different dimensions.

The path metric memory comprises a plurality of memory units of the same amount as the states. The memory units are depicted as the combinations of the symbols and are used for storing the corresponding path metrics of the set of states. The memory access device is used for reading out the path metrics from the path metric memory according to a programmable access control sequence, so as to perform calculation by the non-binary Viterbi processor, and also for writing the updated path metrics back to the path metric memory. The programmable access control sequence comprises a read out sequence and a write back sequence.

The read out sequence sequentially reads out the path metrics from the memory units along a first dimension and obtains a set of updated path metrics via the calculation of a Viterbi decoding procedure. The write back sequence writes the set of updated path metrics back to the same memory units along the first dimension until all the path metrics in the memory units are updated. Next, the read out sequence redirects and reads out the path metrics from the memory units along a second dimension and obtains a set of updated path metrics via the calculation of a Viterbi decoding procedure. The write back sequence sequentially writes the set of updated path metrics back to the same memory units along the second dimension until all the path metrics in the memory units are updated. Accordingly, merely the same amounts of memory units in the path metric memory as the states are required to update the set of path metrics.

Accordingly, the present invention merely requires the same amounts of the storage capacity in the path metric memory as the states whereas the prior art must double the storage capacity in the path metric memory to store all calculation results. Therefore, the present invention can effectively reduce the storage capacity in the path metric memory.

The advantage and spirit of the invention may be understood by the following recitations together with the appended drawings.

### BRIEF DESCRIPTION OF THE APPENDED DRAWINGS

FIG. 1 is a schematic diagram of the Viterbi data processing system and the symbol registers of the prior art.

FIG. 2 is a schematic diagram of the Viterbi decoding logic of two symbols of the prior art.

FIG. 3 is a schematic diagram of the Viterbi data processing system of the prior art.

FIG. 4 is a schematic diagram of the ACS module shown in FIG. 3.

FIG. 5 is a schematic diagram of the non-binary Viterbi data processing system of the present invention.

FIG. 6 is a schematic diagram of the path metric memory shown in FIG. 5.

FIG. 7 is a schematic diagram of reading out or writing back data by the path metric memory shown in FIG. 5.

FIG. 8 is a schematic diagram of the non-binary Viterbi processor shown in FIG. 5.

FIG. 9 is a flowchart of the non-binary Viterbi data processing method according to the present invention.

FIG. 10 is a schematic diagram of the non-binary Viterbi data processing system of the second embodiment according to the present invention.

FIG. 11 is a schematic diagram of reading out or writing back data by the path metric memory shown in FIG. 10.

FIG. 12 is a schematic diagram of the non-binary Viterbi data processing system of the third embodiment according to the present invention.

FIG. 13 is a schematic diagram of the path metric memory shown in FIG. 12.

FIG. 14 is a schematic diagram of reading out or writing back data by the path metric memory shown in FIG. 12.

### DETAILED DESCRIPTION OF THE INVENTION

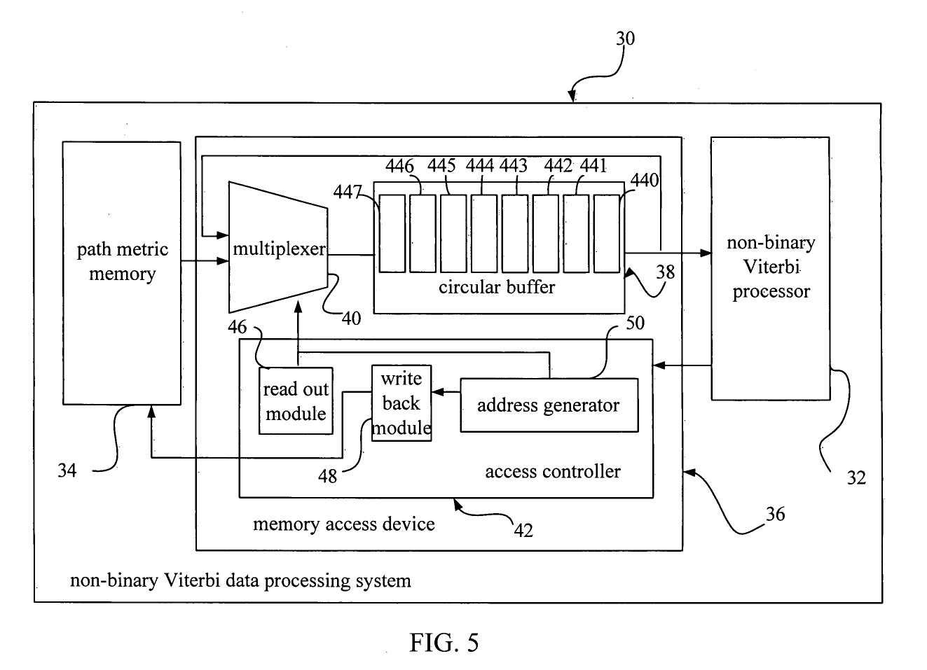

Referring to FIG. 5, FIG. 5 is a schematic diagram of the non-binary Viterbi data processing system 30 of the present invention. The non-binary Viterbi data processing system 30 comprises a non-binary Viterbi processor 32, a path metric memory 34, and a memory access device 36.

The non-binary Viterbi processor 32 is used for obtaining the path metrics of a set of states according to a predetermined Viterbi decoding procedure. The set of states is encoded by a combination of at least two symbols, wherein each symbol represents a different dimension and is encoded by i bits. For example, if each set of states comprises two symbols and each symbol is encoded by 3 bits, there will be 8 possible values comprising 64 ((2³)²) different states.

In an embodiment, the present invention is applied to an 8PSK communication system. The non-binary Viterbi processor 32 is used for decoding the received symbols in the 8PSK communication system. With the characteristics of the 8PSK communication system, each received symbol is encoded by three bits and comprises eight possible values. The 8PSK communication system comprises two symbol registers for temporarily storing two latest received symbols. The two symbols comprise 64 possible values to represent 64 possible states. When the 8PSk communication system receives a new symbol, the state transition is performed. The two symbol registers will erase the earlier received symbols and temporarily store the latest received symbols. The non-binary Viterbi data processing system 30 of the present invention calculates the path metric of each possible state and updates the path metric memory 34 according to the Viterbi data decoding procedure so as to determine the most possible value corresponding to the received symbols.

As the above mentioned in the prior art, if data are decoded in the Viterbi algorithm, it is necessary to obtain the path metrics of each state in each state transition first. The way of calculating the path metrics in the present invention is similar to that in the prior art mentioned above, which won't be described here again. According to the present invention, the main function of the non-binary Viterbi processor 32 is to calculate a plurality of branch metrics of each possible transition path of 64 possible states during each state transition and to update the corresponding path metrics of each state accordingly.

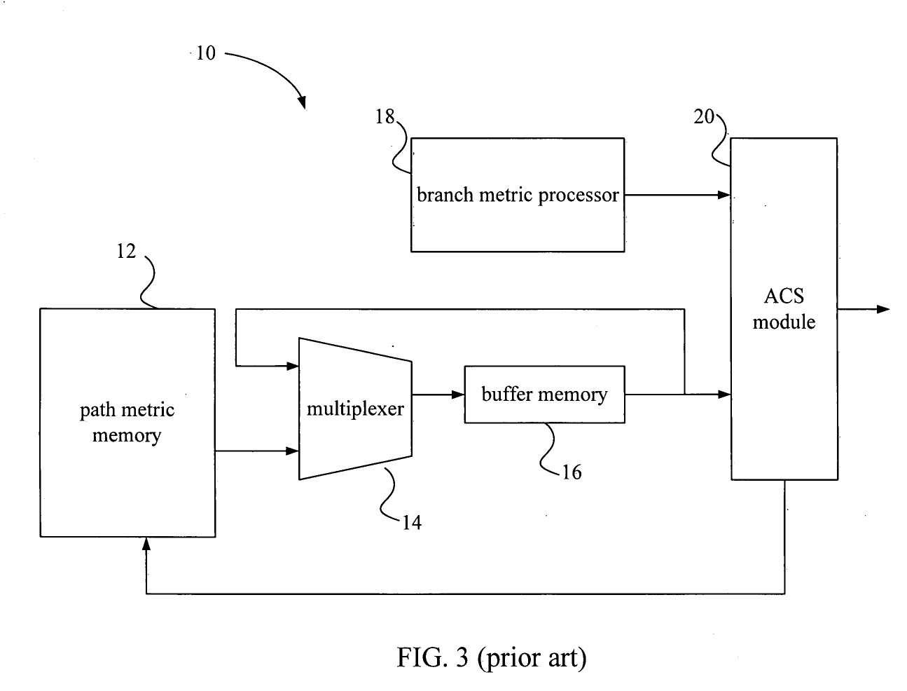

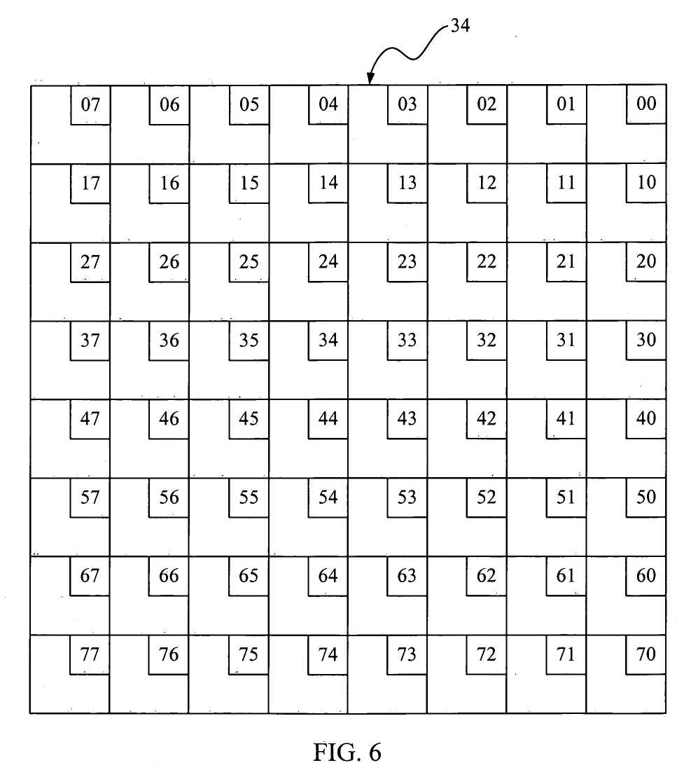

Referring to FIG. 6, FIG. 6 is a schematic diagram of the path metric memory 34 shown in FIG. 5. The path metric memory 34 comprises a plurality of memory units of the same amount as the states. The memory units in the path metric memory 34 are usually lineally displayed. For the purpose of better illustration of the present invention, the memory units here are arranged in an N×N matrix shown in FIG. 6. Person skilled in the art can easily perform the multi-dimensional addressing method to equivalently transform the lineally displayed memory units into the N×N matrix. The N×N matrix will be illustrated to describe the present invention as follows. For example, if there are 64 states, the corresponding quantity of 8×8 memory units will be provided in the path metric memory. 64 memory units are shown in FIG. 6. The memory units are depicted as the combination of symbols with different dimensions for correspondingly storing the path metrics of the states. As shown in FIG. 3, the memory unit depicted as “00” stores the path metric of the state “00”, and so forth.

The present invention utilizes the memory access device 36 to promptly assess the path metric memory 34. As shown in FIG. 5, the memory access device 36 comprises a circular buffer 38, a multiplexer 40, and an access controller 42. The circular buffer 38 comprises 8 lineally displayed circular buffer units 440˜447 for circularly accessing the corresponding path metrics of all preceding possible states with respect to a predetermined set of states.

The multiplexer 40 is used for receiving inputs from the memory units of the path metric memory 34 and the circular buffer units 440˜447 of the circular buffer 38, and for selecting and writing one of the two path metrics back to the circular buffer units 440˜447 of the circular buffer 38 according to a control signal.

The access controller 42 is used for sending the control signal to control the multiplexer 40 and the circular buffer 38, for reading out the path metrics from the path metric memory 34 for further calculation by the non-binary Viterbi processor 36 according to a programmable access control sequence, and for writing the updated path metrics back to the path metric memory 34. The programmable access control sequence comprises a read out sequence and a write back sequence.

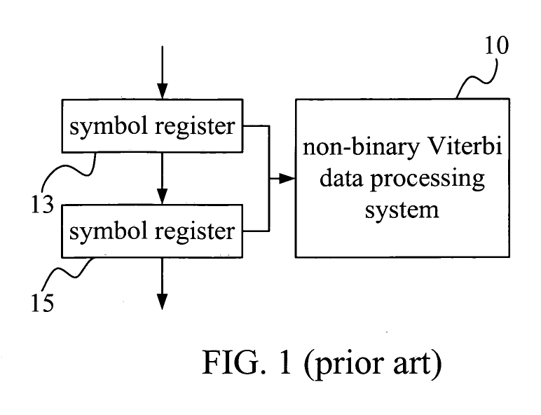

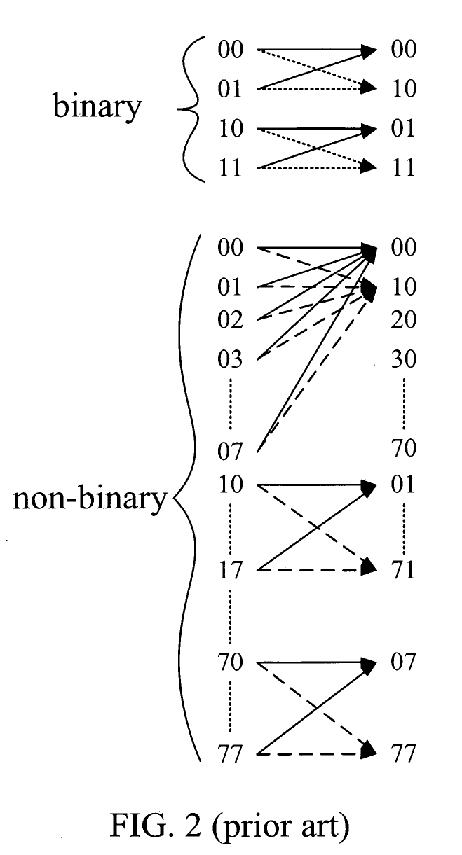

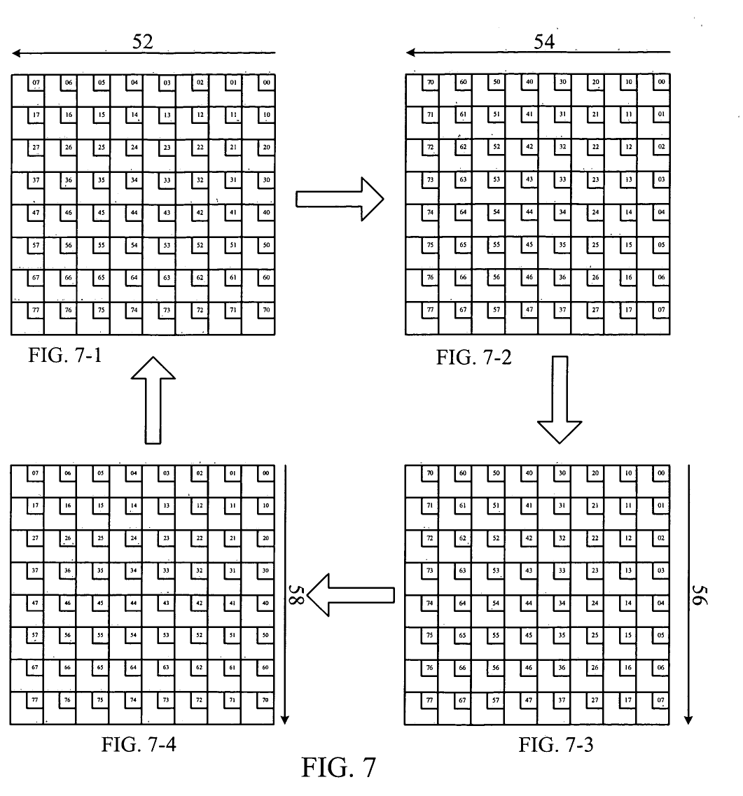

As shown in FIG. 5, the access controller 42 comprises a read out module 46 and a write back module 48. Referring to FIG. 7, FIG. 7 is a schematic diagram of reading out or writing back data by the path metric memory 34 shown in FIG. 5. As shown in FIG. 7-1, when the non-binary Viterbi data processing system 30 of the present invention starts to update the path metrics of the path metric memory 34, the read out module 46, according to the read out sequence, sends the control signal to request the multiplexer 40 to sequentially read out the path metrics corresponding to the states 00, 01 . . . 07 in the memory unit along the first dimension (shown as the arrow 52 in FIG. 7). The path metrics are temporarily stored in 8 circular buffer units 440˜447 of the circular buffer 38. Then, the path metrics are calculated via the Viterbi data decoding procedure by the non-binary Viterbi processor 32 to sequentially obtain the updated path metrics of the states 00, 10 . . . 70. As shown in FIG. 7-2, the write back module 48, according to the write back sequence, writes the updated path metrics of the states 00, 10 . . . 70 back to the same memory units along the first dimension (shown as the arrow 54 in FIG. 7). After that, the read out module 46, according to the read out sequence, sequentially reads out the path metrics corresponding to the states 10, 11 . . . 17 in the memory unit along the first dimension shown in FIG. 7. The path metrics are temporarily stored in 8 circular buffer units 440˜447 of the circular buffer 38. Then, the path metrics are calculated with the Viterbi data decoding procedure by the non-binary Viterbi processor 32 to sequentially obtain the updated path metrics of the states 01, 11 . . . 71. As shown in FIG. 7-2, the write back module 48, according to the write back sequence, writes the updated path metrics of the states 01, 11 . . . 71 back to the same memory units along the first dimension. The above procedure will be performed until the path metrics in all of the memory units are updated. As the update of the path metrics stored in the path metric memory 34 is completed, the memory units are changed diagonally in the path metric memory 34. In other word, it is viewed as a swap-over between the first dimension and the second dimension.

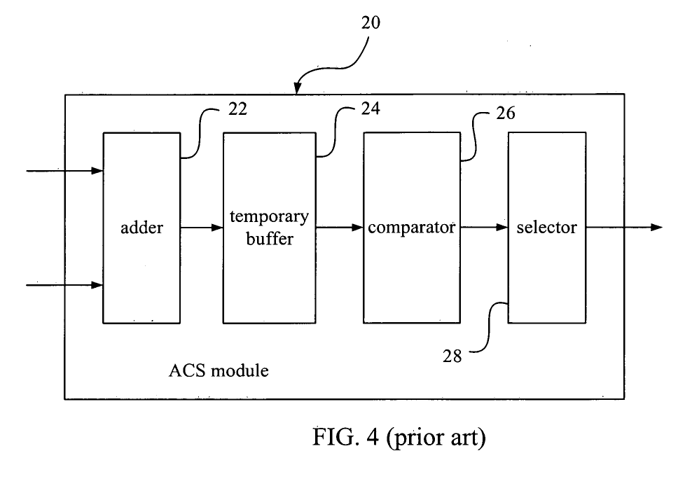

As shown in FIG. 7-3, when the non-binary Viterbi data processing system 30 of the present invention needs to update the path metrics of the path metric memory 34 again, the read out sequence sequentially reads out the path metrics corresponding to the states 00, 01 . . . 07 in the memory unit along a second dimension (shown as the arrow 56 in FIG. 7). Then, the path metrics are calculated via the Viterbi data decoding procedure by the non-binary Viterbi processor 32 to sequentially obtain the updated path metrics of the states 00, 10 . . . 70. As shown in FIG. 7-4, the write back sequence sequentially writes the updated path metrics of the states 00, 10 . . . 70 back to the same memory units along the second dimension (shown as the arrow 58 in FIG. 7). After that, the read out module 46, according to the read out sequence, sequentially reads out the path metrics corresponding to the states 10, 11 . . . 17 in the memory unit along the second dimension. The path metrics are temporarily stored in 8 circular buffer units 440˜447 of the circular buffer 38. Then, the path metrics are calculated via the Viterbi data decoding procedure by the non-binary Viterbi processor 32 to sequentially obtain the updated path metrics of the states 01, 11 . . . 71. As shown in FIG. 7-4, the write back sequence sequentially writes the updated path metrics of the states 01, 11 . . . 71 back to the same memory units along the second dimension. The above procedure will be performed until the path metrics in all of the memory units are updated. After the present invention updates the path metrics stored in the path metric memory 34, the memory units are changed diagonally in the path metric memory 34 again. It is viewed as a swap-over between the first dimension and the second dimension again. Therefore, the state of FIG. 7-4 returns back to the state of FIG. 7-1 and be ready to update the path metrics in the path metric memory 34 next time.

Because the path metric memory 34 is an N×N matrix, when the first dimension is depicted as a column of the path metric memory 34, the second dimension is a row of the path metric 34; and when the first dimension is depicted as a row of the path metric memory 34, the second dimension is a column of the path metric memory 34. As mentioned above, the memory units in the path metric memory 34 are not always arranged in a matrix. Person skilled in the art can easily utilize the multi-dimensional addressing method to equivalently transform the lineally displayed memory units into the N×N matrix.

The access controller 42 comprises an address generator 50 for generating a corresponding memory address. The read out sequence sent out by the read out module 46 of the access controller 42 reads out the path metrics from the corresponding memory units of the path metric memory 34 according to the memory address generated by the address generator 50. The write back sequence sent out by the write back module 48 of the access controller 42 writes the updated path metrics generated from the Viterbi data processor back to the corresponding memory units according to the memory address generated by the address generator 50.

According to the above mentioned, the memory access device 36 repeatedly reads out the path metrics from the path metric memory 34 and writes the path metrics back to the path metric memory 34 along the first dimension and the second dimension for updating the path metrics in an alterative-odd-and-even way. Accordingly, instead of using double memory space to store the path metrics in the prior art, the path metric memory 34 of the present invention only needs the same amounts of memory units as the states to constantly update the set of path metrics. Moreover, when updating the path metrics of a specific state, the read out module 46 reads out the corresponding path metrics of all preceding possible states with respect to the specific state and temporarily stores the corresponding path metrics in the circular buffer 38 for circular use afterward. For example, when the original path metrics PM(00), PM(01) . . . PM(07) of the states 00, 01 . . . 07 are read out and temporarily stored in the circular buffer 38, they can be used to calculate the updated path metrics PM(00), PM(10) . . . PM(70) of the states 00, 10 . . . 70. For example, if b=0, the updated path metric PM(b0)=PM(00) of the state 00 is the smallest value selected from the 8 values PM₀(00), PM₁(00) . . . PM₇(00). PM₀(00) is generated by adding up the original path metric PM(00) of the state 00 to the branch metric BM(000). PM₁(00) is generated by adding up the original path metric PM(01) of the state 01 to the branch metric BM(001). Therefore, the path metric PM(00) will be sequentially shifted out from the first circular buffer unit 440 by the following path metric PM(01). Finally, the path metric PM(00) is shifted to the last circular buffer unit 447 for the non-binary Viterbi data processor 32 to calculate the path metric PM(01) and the branch metric BM(001). Similarly, PM₇(00) is generated by adding up the original path metric PM(07) of the state 07 to the branch metric BM(007). When PM₇(00) is calculated, the path metric PM(07) has been shifted to the first circular buffer unit 440 for the non-binary Viterbi data processor 32 to calculate the path metric PM(07) and the branch metric BM(007).

After the above calculation is completed, the path metric PM(07) will be shifted out from the first circular buffer unit 440 and the subsequent path metric PM(00) will be shifted forward sequentially, so that the path metrics PM(00), PM(01) . . . PM(07) completely cycle around in the circular buffer 38. Similarly, to calculate the updated path metrics PM(10), PM(20) . . . PM(70) of each of the states 10, 20 . . . 70, the original path metrics PM(00), PM(01) . . . PM(07) of the states 00, 01 . . . 07 are also necessary. During this period, the path metrics PM(00), PM(01) . . . PM(07) are repeatedly utilized in the circular buffer 38. Therefore, the system doesn't need to read out data from the path metric memory 34. Not until the updated path metrics PM(01), PM(11) . . . PM(71) of the states 01, 11 . . . 71 start to be calculated, that the original path metrics PM(10), PM(11) . . . PM(17) of the states 10, 11 . . . 17 are read out and temporarily stored in the circular buffer 38. After that, the similar procedure is performed to update the path metrics, and the updated path metrics are written back to the original memory unit of the path metric memory 34. As shown in FIG. 5, 7-1, and 7-2, the above procedure will last until the path metrics PM(00), PM(01) . . . PM(77) in all of the memory units of the path metric memory 34 are updated. Therefore, the present invention utilizes the circular buffer 38 to effectively reduce the accessing frequencies of the path metric memory 34. Furthermore, the prior art frequently assesses the buffer memory. Whenever the predetermined state is calculated, the path metric memory has to be read again. Therefore, the problems of the frequent assess and long processing time are presented in the prior art. Here, the present invention solves the problems by reducing assessing frequencies and shortening the processing time of the system.

It has to be emphasized that the method of the present invention for accessing the path metric memory 34 is different from that of the prior art. For example, when the method of the present invention for updating the path metrics is applied to an 8PSK communication system, the present invention first reads out the 8 possible states 01˜07, and stores the possible states in the circular buffer 38. The present invention further respectively adds up the path metrics of the 8 possible states to the corresponding branch metrics, selects the smallest from the results to obtain an updated path metric of the predetermined state, and writes back to the memory unit of the path metric memory 34. After calculating the 8 predetermined states corresponding to the 8 possible states (i.e. 00˜07 transformed to 00, 10, 20 . . . 70), the path metrics of the corresponding new states have already been written back to the memory unit along the preceding reading direction and replaced the path metrics of the calculated 8 possible states. The path metrics of the set of 8 possible states have been completely calculated, which are not related to updating the path metrics of other sets of possible states and won't be used by the system again. Therefore, the path metrics of the updated states can replace the path metrics originally stored in the corresponding memory units of the path metric memory 34 without affecting the updating procedure of the path metrics in the system.

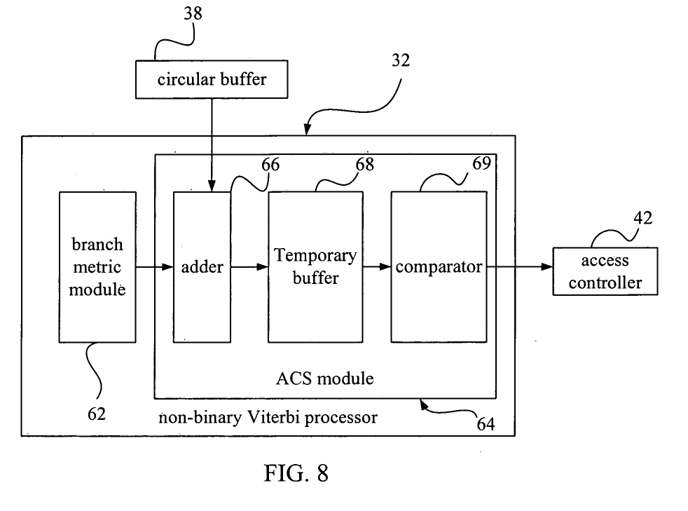

The operation of the non-binary Viterbi processor will be described in the following. Referring to FIG. 8, FIG. 8 is a schematic diagram of the non-binary Viterbi processor 32 shown in FIG. 5. The non-binary Viterbi processor 32 comprises a branch metric calculation module 62 and an add-compare-select module (ACS module) 64.

The branch metric calculation module 62 is used for obtaining the corresponding branch metrics between the predetermined set of states and the preceding possible states in each state transition according to the Viterbi decoding procedure. Taking the 8PSK communication system as an example, the preceding possible states of the predetermined set of 8 states 00, 10, 20 . . . 70 is the corresponding set of 8 states 00, 01, 02 . . . 07, wherein each of the predetermined states needs to calculate the branch metrics of the 8 preceding possible states.

According to equation 1, the ACS module 64 is used for respectively adding up the branch metrics BM(b0a) to the corresponding path metrics PM(0a) of the preceding possible states to obtain a plurality of corresponding candidates of the path metrics PMₐ(b0). Furthermore, the candidates of the path metrics are compared to select one candidate of the path metrics for updating the path metrics of the predetermined set of states. For example, in the 8PSK communication system, after each of the predetermined states calculates the branch metrics of the 8 possible states, the original path metrics of the possible states stored in the circular buffer 38 are added up to the calculated branch metrics to obtain 8 candidates of path metrics of the predetermined states. Then, the smallest candidate is selected to be the updated path metric of the predetermined state. The write back module 46 may be designed to immediately write the calculated result back to the path metric memory 34 whenever the predetermined state is calculated. The write back module 46 may be also designed to write all the calculated results back to the path metric memory 34 after all of the 8 predetermined states have been completely calculated. Because the path metrics of the 8 preceding possible states stored in the circular buffer can be used to calculate the current 8 predetermined states, after the write back module writes back the current updated path metrics of the 8 predetermined states, the read out module 44 sends out the control signal to control the multiplexer to retrieve the path metrics of another 8 possible states (10˜17) of another row or another column.

The components in the ACS module are described in detail as follows. As shown in FIG. 8, the ACS module 64 comprises an adder 66, a temporary buffer 68, and a comparator 69. The adder 66 is used for adding a new branch metric BM(b0a) of the possible state calculated by the branch metric calculation module 62 up to the corresponding path metrics PM(0a) transmitted form the memory access device 36 to obtain a candidate of the path metrics PMₐ(b0) corresponding to the possible state. There are two different way to implement the temporary buffer 68. One is used for sequentially storing the candidates of the path metrics of all possible states of the predetermined state and the other is used for only storing the candidates of the path metrics of two possible states.

The comparator 69 is used for comparing the candidates of the path metrics stored in the temporary buffer 68. In contrast with different designs of the temporary buffer 68, the comparator 69 may be designed to compare two of the candidates of the path metrics originally stored in the temporary buffer 68 and to store the smallest candidate into the temporary buffer 68. Or, after all candidates of the path metrics have been stored into the temporary buffer 38, the comparator 69 then compares each candidate of the path metrics to obtain the smallest candidate of the path metrics as the updated path metric of the predetermined state.

Whenever the comparator 69 of the ACS module 64 completely compares each candidate of the path metrics, the circular buffer will be triggered by the control signal to sequentially shift the path metrics stored in the circular buffer unit. This function can be also designed to trigger the control signal after the adder 66 completes one calculation.

As shown in FIG. 5 and FIG. 8, when the comparator 69 completely compares each candidate of the path metrics, the path metrics stored in the circular buffer 38 will completely shift in a circular cycle. The updated path metrics generated from the ACS module 64 are written back to the corresponding memory unit according to the memory address generated from the address generator 50. The ACS module 64 continually updates the path metrics of the next predetermined state.

The path metric memory 34 comprises a set of memory units with N rows and N columns for correspondingly storing the path metrics of the states. Therefore, the circular buffer unit 440-447 of the circular buffer 38 temporarily stores the path metrics with respect to a certain row or a certain column of the memory unit. When the ACS module 64 updates the path metrics with respect to the same row or the same column of the memory unit, the same path metrics stored in the circular buffer units 440˜447 will be calculated. When the ACS module 64 completely updates all of the path metrics with respect to the same row or the same column of the memory unit, the access controller 42 sends a new read out sequence for reading out the path metrics of a new row or a new column from the memory unit of the path metric memory 34 and writes back to the circular buffer unit 440˜447 of the circular buffer 38 for the ACS module 64 to continually update the path metrics.

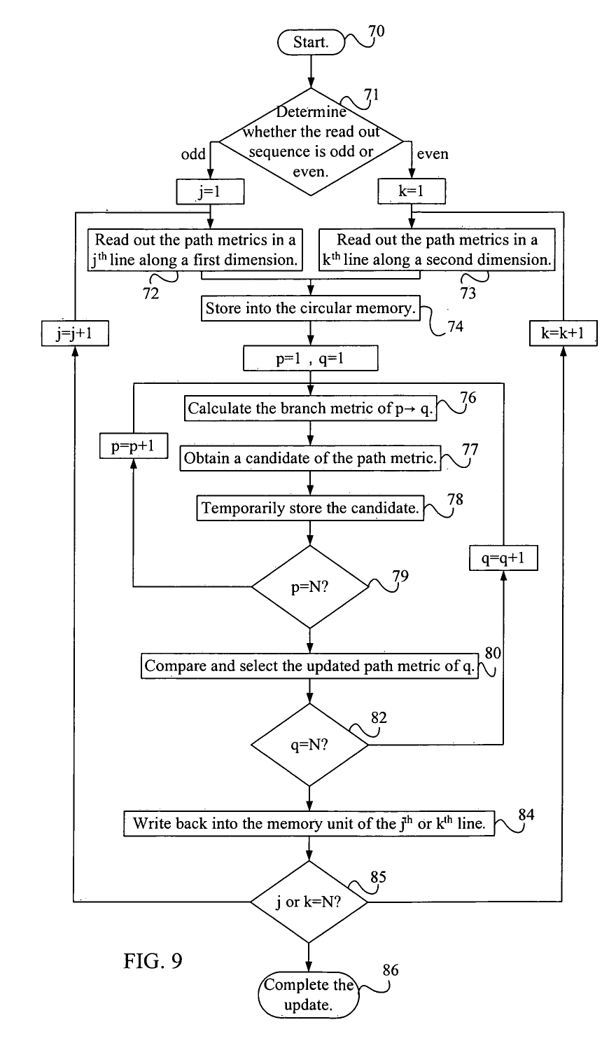

According to the above description, the present invention achieves the objective of effectively saving the memory of the path metric memory 34 by simple control of the memory access. Referring to FIG. 9, FIG. 9 is a flowchart of the non-binary Viterbi data processing method according to the present invention. The non-binary Viterbi data processing method comprises the following steps:

Step S70: Start.

Step S71: Determine whether the read out sequence is odd or even. If the read sequence is odd, go to step S72; otherwise, go to step S73.

Step S72: According to a read out sequence, read out the path metrics stored in all of the memory units of a j^{th} line along a first dimension in the path metric memory 34, wherein j=1˜N, and then go to step S74.

Step S73: According to another read out sequence, read out the path metrics stored in all of the memory units of a k^{th} line along a second dimension in the path metric memory 34, wherein k=1˜N, and then go to step S74.

Step S74: Store the path metrics of the possible states of the line into the circular buffer 44 by the multiplexer 42.

Step S76: Calculate the branch metric of the q^{th} predetermined state from the p^{th} possible state by the branch metric processor, wherein p=1˜N and q=1˜N.

Step S77: Add up the path metric of the p^{th} possible state to the corresponding branch metric by the adder to obtain a candidate of the path metric.

Step S78: Store the candidate of the path metric.

Step S79: Determine whether p is equal to N. If YES, go to step S80; otherwise, set p=p+1and go to step S76.

Step S80: Compare N candidates of the path metrics and select the smallest candidate to be the updated path metric of the q^{th} predetermined state.

Step S82: Determine whether q is equal to N. If YES, go to step S84; otherwise, set q=q+1 and go to step S76 again.

Step S84: According to whether the sequence is odd or even, write back the path metrics of the predetermined state into the memory unit of the j^{th} line or the k^{th} line along the first or second dimension by the write back module.

Step S85: Determine whether j or k is equal to N. If NO, set j=j+1 or k=k+1 and go to step S72 or S73; otherwise, go to step S86.

Step S86: Complete the update.

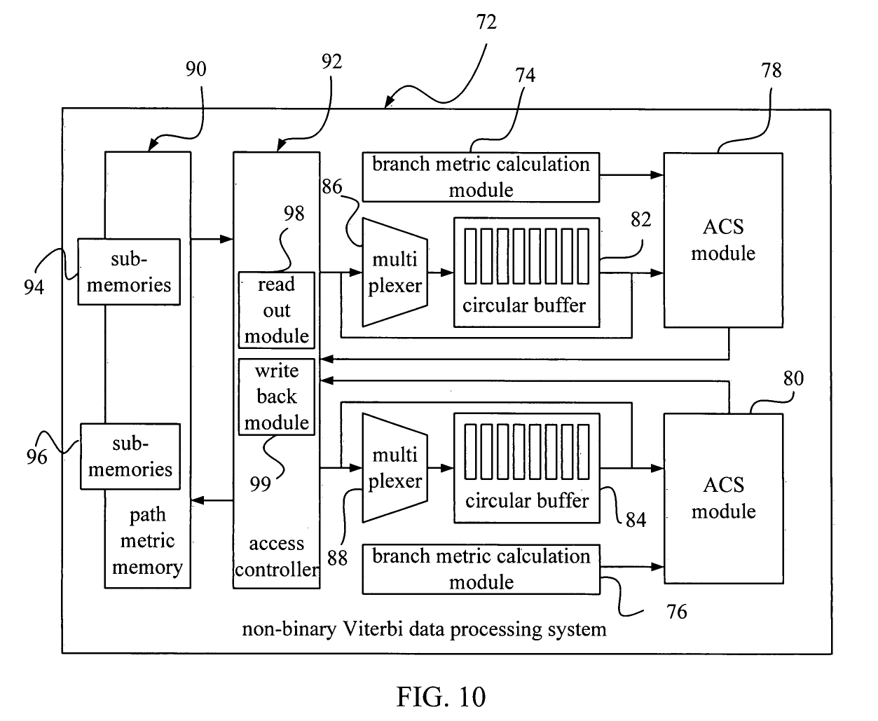

The present invention mentioned in the above utilizes a complete path metric memory to read out or write back various path metrics. Practically, however, the memory is usually divided into a plurality of sub-memories for full use of the path metric memory or for acceleration of the update speed. Referring to FIG. 10, FIG. 10 is a schematic diagram of the non-binary Viterbi data processing system 72 of the second embodiment according to the present invention. The biggest difference between the second embodiment of the present invention and the above first embodiment is that the path metric memory is divided into a plurality of sub-memories. The second embodiment divides the path metric memory 34 of the first embodiment into two sub-memories for respectively and independently accessing data. Accordingly, the non-binary Viterbi data processing system 72 has to comprise two sets of elements similar to those of the first embodiment for accessing two sub-memories at the same time.

The non-binary Viterbi data processing system 72 comprises two branch metric calculation modules 74, 76, two ACS modules 78, 80, two circular buffers 82, 84, two multiplexers 86, 88, a path metric memory 90, and an access controller 92. As described above, the path metric memory 90 consists of two sub-memories 94, 96, which can simultaneously read out and write back data. The access controller 92 comprises a read out module 98 and a write back module 99. The read out module 98 is used for sending the read out sequence to read out the path metrics from the memory units of the sub-memories and for storing the path metrics into the corresponding circular buffer. The write back module 99 is used for sending the write back sequence to write back the updated path metrics, which are generated by the two ACS modules 78 and 80, into the corresponding memory units. In this embodiment, each of the circular buffers 82 and 84 comprises 8 circular buffer units for respectively storing 8 path metrics read out from the path metric memory 90.

Each of the ACS modules 78 and 80 comprises an adder and a comparator. Each of the adders is used for adding a new branch metric calculated by the branch metric calculation module up to the corresponding path metrics transmitted from the memory access device to obtain a corresponding candidate of the path metrics. The comparator is used for comparing all the candidates of the path metrics to obtain the smallest candidate of the path metrics to be the updated path metric of the predetermined states. Beside the procedures for reading out or writing back data, the design of other elements is similar to those of the first embodiment, and it will not be described again.

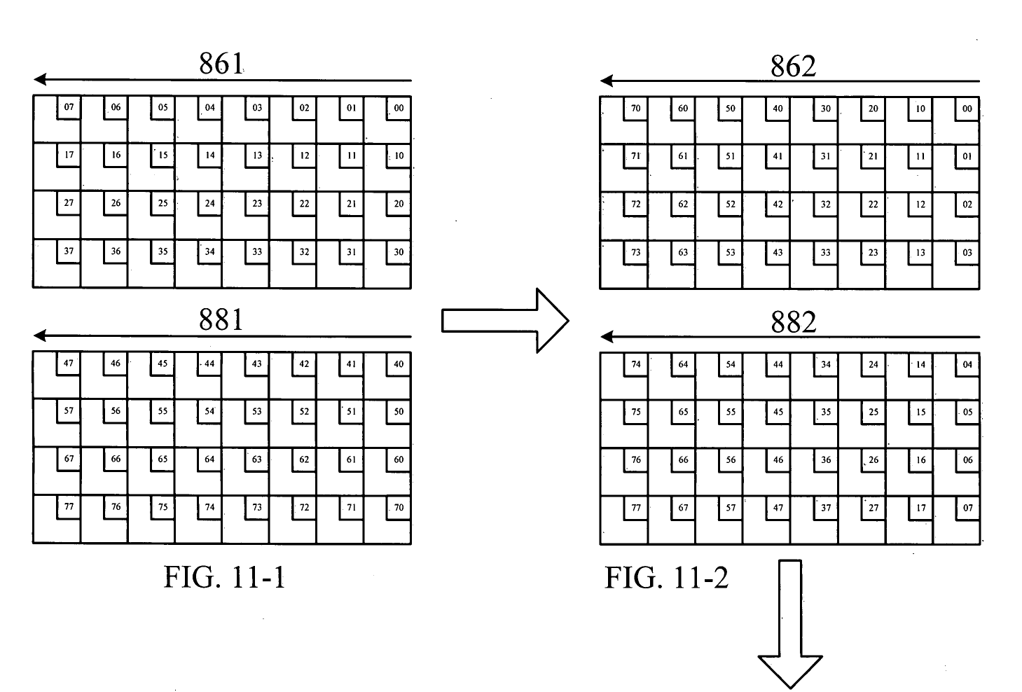

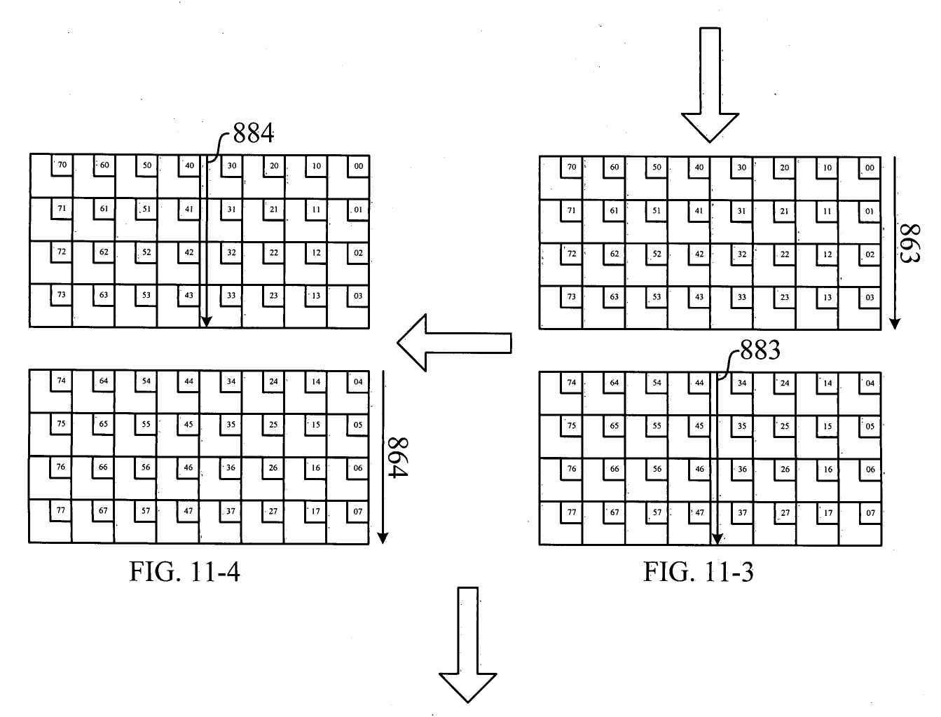

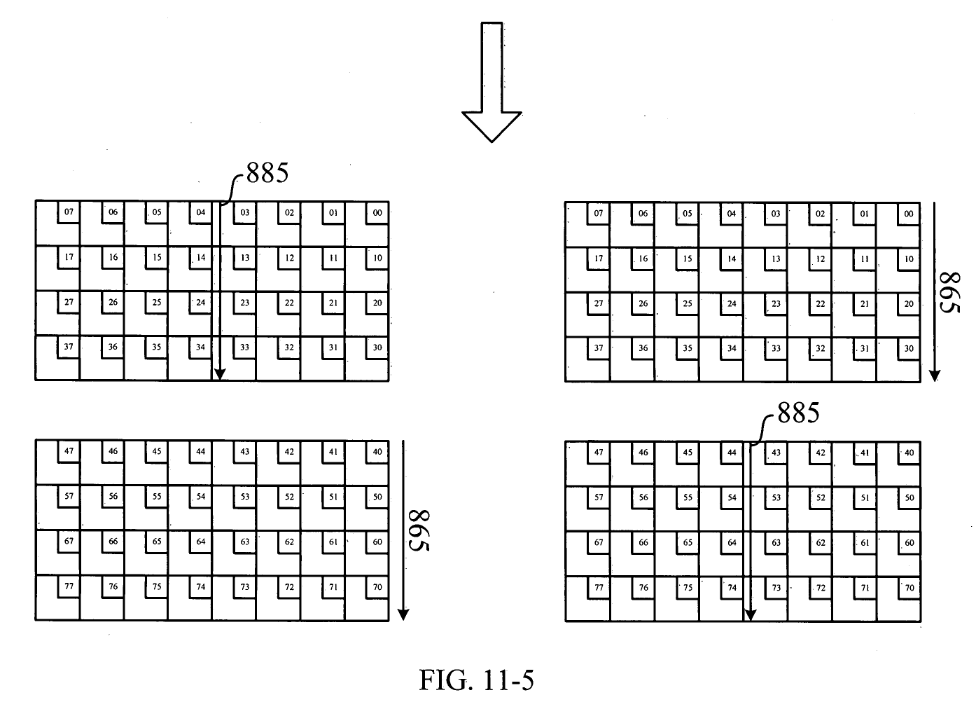

Referring to FIG. 11-1 through 11-5, FIG. 11 is a schematic diagram of reading out or writing back data by the path metric memory 90 shown in FIG. 10. The memory unit in the sub-memories is an 8×4 matrix. As shown in FIG. 11-1, when the non-binary Viterbi data processing system 72 of the present invention starts to update the path metrics of the path metric memory 90, according to the read out sequence, the access controller 92 sends the control signal to sequentially read out the path metrics stored in the sub-memories 94 along a first dimension (shown as the arrow 861 in FIG. 11-1) and to store the path metrics in the circular buffer 82. Then, the path metrics are calculated via the Viterbi data decoding procedure to obtain a set of updated path metrics. At the same time, the access controller 92, according to the read out sequence, sends another control signal to sequentially read out the path metrics stored in the sub-memories 96 along a first dimension (shown as the arrow 881 in FIG. 11-1) and to store the path metrics in the circular buffer 84. Then, the path metrics are calculated via the Viterbi data decoding procedure to obtain a set of updated path metrics.

As shown in FIG. 11-2, after the updated path metrics are obtained, the access controller 92, according to the write back sequence, writes the updated path metrics back to the same sub-memories 94 along the first dimension (shown as the arrow 862 in FIG. 11-2). The above procedure repeats until the path metrics in all of the memory units of the sub-memories 94 are updated. At the same time, the access controller 92, according to the write back sequence, also writes the updated path metrics back to the same sub-memories 96 along the first dimension (shown as the arrow 882 in FIG. 11-2). The above procedure repeats until the path metrics in all of the memory units of the sub-memories 96 are updated.

As shown in FIG. 11-3, when the non-binary Viterbi data processing system 72 of the present invention needs to update the path metric memory 90 again, the access controller 92 sequentially reads out the path metrics in the memory units of the sub-memories 94 and 96 along a second dimension (shown as the arrows 863, 883, 864, and 884 in FIG. 11-3). Because the sub-memories only have 4 memory units along the second dimension, the path metrics in 8 memory units have to be read out in two separate times. As shown in FIG. 11-3, the access controller 92 first reads out the path metrics of the states 01˜04 from the sub-memories 94 for the multiplexer 86 to temporarily store the set of path metrics into the circular buffer 82. At the same time, the access controller 92 reads out the path metrics of the states 44˜47 from the sub-memories 96 for the multiplexer 88 to temporarily store the set of path metrics into the circular buffer 84. As shown in FIG. 11-4, the access controller 92 then reads out the path metrics of the states 40˜43 from the sub-memories 94 for the multiplexer 88 to temporarily store the set of path metrics into the circular buffer 84. At the same time, the access controller 92 reads out the path metrics of the states 04˜07 from the sub-memories 96 for the multiplexer 86 to temporarily store the set of path metrics into the circular buffer 82. Then, via the Viterbi data decoding procedure, two sets of updated path metrics are obtained.

As shown in FIG. 11-5, after the updated path metrics are obtained, the access controller 92 sequentially writes the two sets of updated path metrics back to the same memory units along the second dimension until the path metrics in all of the memory units are updated. Therefore, the present invention can be applied to the path metric memory divided into a plurality of sub-memories. Numerous applications of the present invention may be provided, which cannot be described all in detail. The present invention utilizes the path metric memory divided into two sub-memories to illustrate, instead of limiting, an embodiment.

The above embodiment of the present invention utilizes two symbol registers. However, the method of the present invention for updating the path metrics may also utilize three symbol registers. When utilizing three symbol registers, each decoded state of the present invention will comprise three symbols, wherein each symbol is encoded by 3 bits. Therefore, each symbol comprises 8 possible values for representing (2³)³=512 possible states.

In the non-binary Viterbi data processing system, in which a state consists of three symbols, the path metric of a predetermined state 000 can be obtained by calculating the path metrics of four possible states 000, 001, 002, and 003. The path metrics of the three predetermined states 100, 200, and 300 can also be obtained by calculating the path metrics of four possible states 000, 001, 002, and 003. Similarly, the path metrics of four predetermined states 010, 110, 210, and 310 can be obtained by calculating the path metrics of four possible states 010, 011, 012, and 013. Other states can also be obtained via the same procedure. Therefore, in the non-binary Viterbi data processing system, in which a state consists of three symbols, the first embodiment of the present invention can be slightly modified to achieve the same advantage.

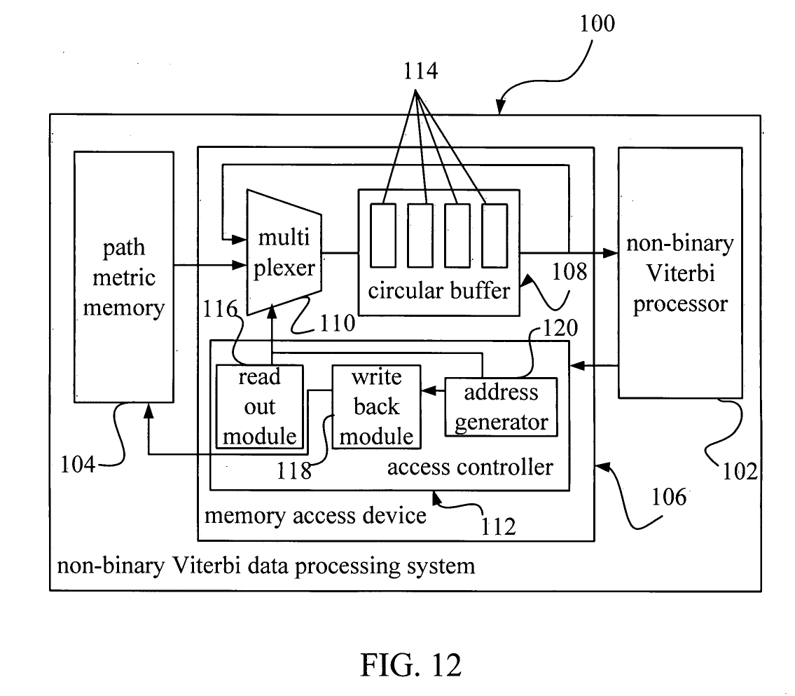

As shown in FIG. 12, FIG. 12 is a schematic diagram of the non-binary Viterbi data processing system 100 of the third embodiment according to the present invention. The non-binary Viterbi data processing system 100 comprises a non-binary Viterbi processor 102, a path metric memory 104, and a memory access device 106.

The functions of the elements in the third embodiment are similar to those in the first embodiment, except that each state in the third embodiment consists of three symbols. In the third embodiment, the structure of the path metric memory 104 is depicted as a three-dimensional model. The memory access device 106 therefore has to read out or write back the path metrics of each state from or into the path metric memory 104 along the three dimensions respectively.

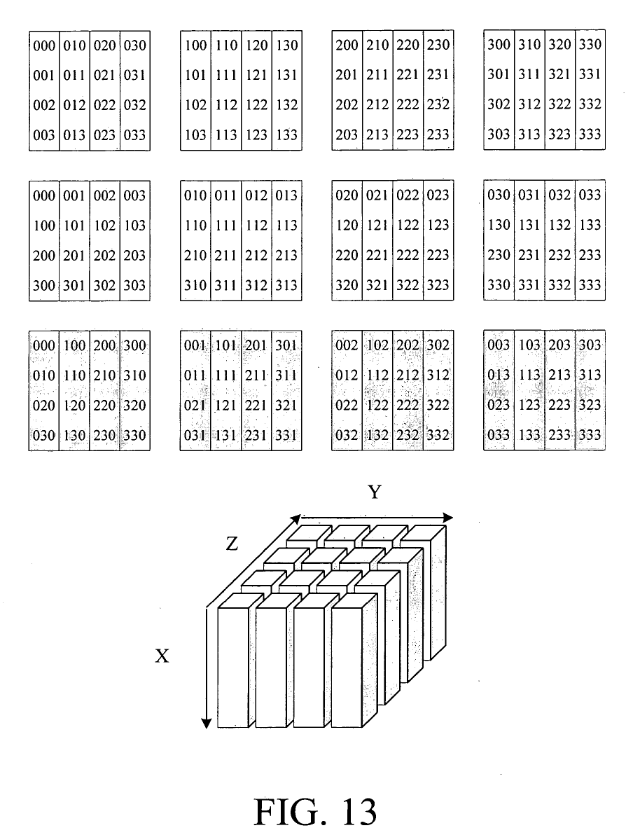

Referring to FIG. 13, FIG. 13 is a schematic diagram of the path metric memory 104 shown in FIG. 12. The path metric memory 104 comprises a plurality of memory units of the same amount as the states. As shown in FIG. 13, each state in the path metric memory 104 comprises three symbols and each symbol is encoded by 2 bits (i.e. (2²)³ states and 64 memory units are required). The memory units, which are also depicted by the combinations of the symbols of different dimensions, are used for storing the path metrics of the corresponding states. The memory unit “000” represents that the memory unit is used for storing the path metrics of the state “000”, and so forth.

The present invention utilizes the memory access device 106 to promptly access the path metric memory 104. As shown in FIG. 11, the memory access device 106 comprises a circular buffer 108, a multiplexer 110, and an access controller 112. The functions of the circular buffer and the multiplexer are the same as those in the first embodiment, which will not be described again. However, since each state comprises three symbols, the access controller 112 needs to utilize the addressing method along three dimensions to sequentially read out or write back the path metrics of each state from or into the path metric memory.

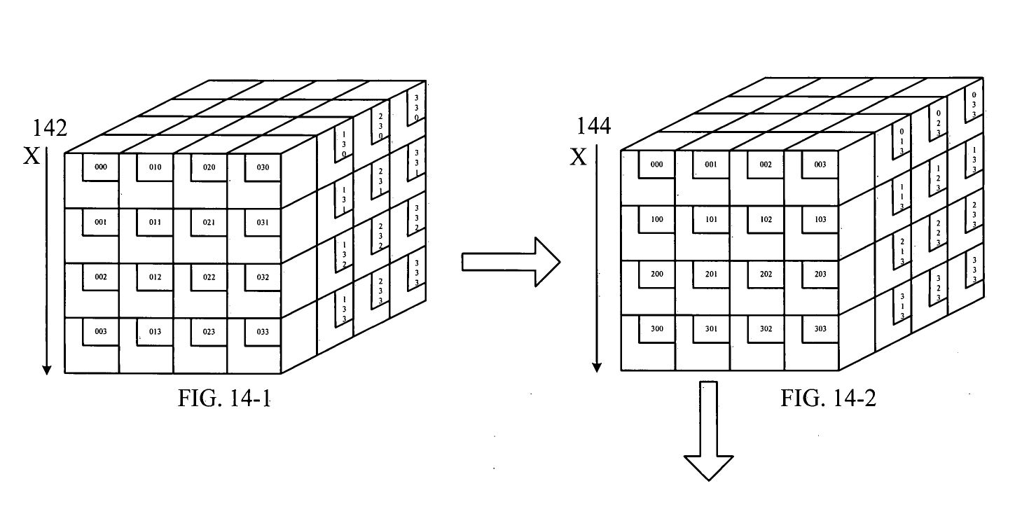

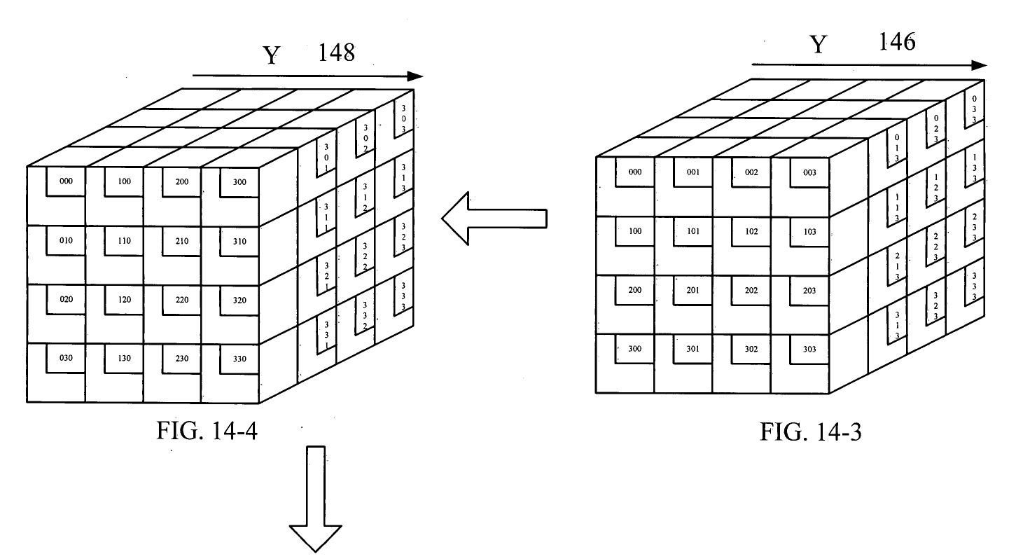

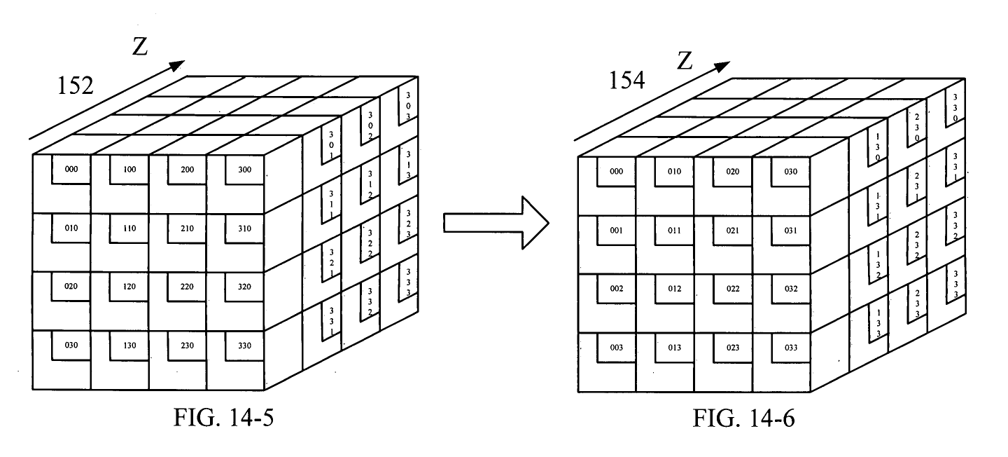

As shown in FIG. 12, the access controller 112 comprises a read out module 116 and a write back module 118. Referring to FIG. 14-1 through 14-6, FIG. 14 is a schematic diagram of reading out or writing back data by the path metric memory 104 shown in FIG. 12. As shown in FIG. 14-1, when the non-binary Viterbi data processing system 100 of the present invention starts to update the path metrics of the path metric memory 104, the read out module 1˜16, according to the read out sequence, sends the control signal to sequentially read out the path metrics stored in the memory units along a first dimension (the X direction shown as the arrow 142 in FIG. 14). Then, the path metrics are calculated via the Viterbi data decoding procedure to obtain a set of updated path metrics. As shown in FIG. 14-2, the write back module 118, according to the write back sequence, writes the updated path metrics back into the same memory units along the first dimension (the X direction shown as the arrow 144 in FIG. 14). The above procedure repeats until the path metrics in all of the memory units are updated.

As shown in FIG. 14-3, when the non-binary Viterbi data processing system 100 of the present invention needs to update the path metric memory 104 again, the read out sequence 114 sequentially reads out the path metrics in the memory units along a second dimension (the Y direction shown as the arrow 146 in FIG. 14-3). Then, the path metrics are calculated via the Viterbi data decoding procedure to obtain a set of updated path metrics. As shown in FIG. 14-4, the write back sequence 1 16 writes the updated path metrics back to the same memory units along the second dimension (the Y direction shown as the arrow 148 in FIG. 14-4) until the path metrics in all of the memory units are updated.

As shown in FIG. 14-5, when the non-binary Viterbi data processing system 100 of the present invention needs to update the path metric memory 104 again, the read out sequence 114 sequentially reads out the path metrics in the memory units along a third dimension (the Z direction shown as the arrow 152 in FIG. 14-5). Then, the path metrics are calculated via the Viterbi data decoding procedure to obtain a set of updated path metrics. As shown in FIG. 14-6, the write back sequence 116 writes the updated path metrics back to the same memory units along the third dimension (the Z direction shown as the arrow 154 in FIG. 14-6) until the path metrics in all of the memory units are updated.

Because the path metric memory 104 is an Nₓ×N_{y}×N_{z} matrix, when the first dimension is an x direction of the path metric memory 104, the second dimension is a y direction of the path metric memory and the third dimension is a z direction of the path metric memory. On the other hand, when the first dimension is a y direction of the path metric memory 104, the second dimension is a z direction of the path metric memory and the third dimension is an x direction of the path metric memory.

The access controller 112 comprises an address generator 120 for generating a corresponding memory address. The read out sequence sent out by the read out module 116 of the access controller 112 reads out the path metrics from the corresponding memory units of the path metric memory according to the memory address generated by the address generator 120. The write back sequence sent out by the write back module 118 of the access controller 112 writes the updated path metrics generated from the non-binary Viterbi data processor 102 back to the corresponding memory units according to the memory address generated by the address generator 120.

According to the above mentioned, the memory access device 116 of the third embodiment of the present invention repeatedly reads out the path metrics from the path metric memory 104 and writes back the updated path metrics to the path metric memory 104 along the first dimension, the second dimension, and the third dimension for updating the path metrics in every three cycles. Accordingly, the path metric memory 104 of the present invention only needs the same amounts of memory units as the states to completely update the path metrics.

The functions of the elements in the third embodiment are similar to those in the first embodiment, except that the access manner in the third embodiment is changed from two-dimension (with x-y axis) to three-dimension (with x-y-z axis). The elements corresponding to those in the first embodiment will not be described again.

The present invention reduces the storage capacity in the path metric memory down to the same amounts as the number of states, whereas the prior art has to increase the storage capacity in the path metric memory to store all calculation results. Therefore, the present invention can effectively reduce the storage capacity in the path metric memory. Furthermore, compared with the prior art, the present invention utilizes the circular buffer to circularly store the path metrics of all possible states to effectively reduce the accessing frequencies of the path metric memory. With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A non-binary Viterbi data processing system comprising:
a non-binary Viterbi processor, for obtaining path metrics of a set of states according to a predetermined Viterbi decoding procedure, while in each state transition, for calculating a plurality of branch metrics for each set of states, and for updating the corresponding path metrics of each set of states, the set of states being encoded by combinations of at least two symbols;
a path metric memory comprising memory units of the same amount as the states, the memory units being depicted as the symbol combinations for storing the corresponding path metrics of the set of states; and
a memory access device, reading out the path metrics from the path metric memory for the calculation of the non-binary Viterbi processor according to a programmable access control sequence, and writing the updated path metrics back to the path metric memory, the programmable access control sequence comprising a read out sequence and a write back sequence;
wherein the read out sequence sequentially reads out the path metrics from the memory units along a first dimension and obtains a set of updated path metrics via the calculation of the Viterbi decoding procedure, the write back sequence writes the set of updated path metrics back to the same memory units along the first dimension until all the path metrics in the memory units are updated, the read out sequence redirects and reads out the path metrics from the memory units along a second dimension and obtains a set of updated path metrics via the calculation of the Viterbi decoding procedure, the write back sequence sequentially writes the set of updated path metrics back to the same memory units along the second dimension until all the path metrics in the memory units are updated, therefore merely the same amounts of the memory units as the states in the path metric memory are required for update of the set of path metrics.

2. The data processing system of claim 1, wherein the memory access device repeatedly reads out the path metrics from the path metric memory and writes the path metrics back to the path metric memory along the first dimension and the second dimension for updating the path metrics in an alterative-odd-and-even way.

3. The data processing system of claim 1, wherein the set of states is encoded by two symbols, each symbol is encoded by i bits and comprises 2ⁱ possible values.

4. The data processing system of claim 3, wherein the non-binary Viterbi data processing system is used for decoding the received symbols in a 8PSK communication system, each received symbol is encoded by three bits and comprises eight possible values, the 8PSK communication system comprises two symbol registers for temporarily storing two latest received symbols, two symbols comprise 64 possible values for representing 64 possible states, the non-binary Viterbi processing is used for calculating the path metric of each possible state according to the Viterbi data decoding procedure and then determines the corresponding value of the received symbol.

5. The data processing system of claim 4, wherein when the 8PSk communication system receives a symbol, the state transition is performed, the two symbol registers erase the earlier received symbols and temporarily store the latest received symbols.

6. The data processing system of claim 1, wherein the path metric memory comprises a memory unit with a set of N rows and N columns corresponding to the path metric of the set of states, when the first dimension is depicted as a column of the path metric memory, the second dimension would be a row of the path metric, when the first dimension is depicted as a row of the path metric memory, the second dimension would be a column of the path metric memory.

7. The data processing system of claim 1, wherein the non-binary Viterbi processor comprises:
at least one branch metric calculation module for obtaining the corresponding branch metrics between the predetermined set of states and the preceding possible states in each state transition according to the Viterbi decoding procedure; and
at least one add-compare-select module, for respectively adding up the branch metrics to the corresponding path metrics of the preceding possible states to obtain a plurality of candidates of the path metrics, for comparing the candidates of the path metrics, and for selecting one candidate for updating the path metrics of the predetermined set of states.

8. The data processing system of claim 7, wherein the add-compare-select module comprises:
a temporary buffer for temporarily storing a first candidate of the path metrics;
an adder for adding a new branch metric calculated by the branch metric calculation module up to the corresponding path metrics transmitted from the memory access device to obtain a second candidate of the path metrics; and
a comparator for comparing the first candidate of the path metrics and the second candidate of the path metrics, for selecting a smaller one from the two candidates of the path metrics to be an updated first candidate of the path metrics and to be stored into the temporary buffer;
wherein the comparator compares each candidate of the path metrics and selects the smallest candidate of the path metrics as the updated path metric of the predetermined set of states.

9. The data processing system of claim 8, wherein the memory access device comprises:
at least one circular buffer comprising a plurality of orderly arranged circular buffer units for circularly accessing the corresponding path metrics of all preceding possible states with respect to the predetermined set of states;
at least one multiplexer for receiving the memory units of the path metric memory and the circular buffer units of the circular buffer, and for selecting one of the path metrics to be written back to the circular buffer units of circular buffer according to a control signal; and
an access controller, for sending the control signal to control the multiplexer and the circular buffer, for sending the read out sequence for reading out the path metrics from the memory unit of the path metric memory and temporarily storing in the circular buffer, and for sending the write back sequence for writing the updated path metrics, generated from the add-compare-select module, back to the memory unit.

10. The data processing system of claim 9, wherein the access controller comprises an address generator for generating a corresponding memory address, the read out sequence reads out the path metrics from the corresponding memory units of the path metric memory according to the memory address generated by the address generator, the write back sequence writes the updated path metrics generated from the add-compare-select module, back to the corresponding memory units.

11. The data processing system of claim 9, wherein whenever the comparator of the add-compare-select module compares each candidate of the path metrics, the circular buffer is enabled by the control signal to sequentially shift the path metrics temporarily stored in the circular buffer unit.

12. The data processing system of claim 11, wherein while the comparator completely compares each candidate of the path metrics, the path metrics temporarily stored in the circular buffer will circularly shift; the updated path metrics generated from the add-compare-select module will be written back to the corresponding memory unit according to the memory address generated by the address generator; and the add-compare-select module constantly updates the next predetermined path metrics.

13. The data processing system of claim 12, wherein the path metric memory comprises a set of memory with N rows and N columns for correspondingly storing the path metrics of the states, the circular buffer unit of the circular buffer temporarily stores the path metrics with respect to a row or a column of the memory, when the add-compare-select module updates the path metrics with respect to a same row or a same column of the memory, the same path metrics temporarily stored in the plural circular buffer units are applied to be calculated, when the add-compare-select module updates all of the path metrics with respect to the same row or the same column of the memory, the access controller sends a new read out sequence for reading out the path metrics of a new row or a new column from the memory unit of the path metric memory to temporarily write back to the circular buffer unit of the circular buffer for the add-compare-select module to constantly update the path metrics.

14. The data processing system of claim 9, wherein the data processing system comprises two branch metric calculation modulus, two add-compare-select-modulus, two circular buffers, and two multiplexers, the path metric memory comprises a plurality of sub-memories which can be simultaneously read out or written back, the access controller further comprises:
a read-out unit for sending the read out sequence to read out and temporarily store the path metrics from the sub-memories in the corresponding circular buffer; and
a write-back unit for sending the write back sequence to write the updated path metrics respectively generated by two add-compare-select-modulus, back to the corresponding memory units.

15. The data processing system of claim 7, wherein the add-compare-selective module comprises:
a plurality of adders, each adder is used to add the new branch metric calculated by the branch metric calculation unit with the corresponding path metrics sent from the memory access device for obtaining the candidates of the path metrics; and
a comparator for comparing all of the candidates of the path metrics to obtain the smallest candidate for updating the predetermined path metrics.

16. The data processing system of claim 1, wherein the set of the states is encoded by three symbols, each symbol is encoded by i bits and comprises 2ⁱ possible values for having (2ⁱ)³ possible states, when the read out sequence has completely read out and the write back sequence has written back along the first dimension and the second dimension, the read out sequence sequentially reads out the path metrics of the memory units along a third dimension to obtain a set of updated path metrics via calculation by the Viterbi-encoded procedure, the write back sequence sequentially writes back the set of updated path metrics into the third dimension of the memory until the path metrics of all memory units are updated.

17. A non-binary Viterbi data processing method, for obtaining path metrics of a set of states according to a Viterbi decoding procedure, while in each state transition, for calculating a plurality of branch metrics for each set of states, and for updating the corresponding path metrics of each set of states, the set of states being encoded by combinations of at least two symbols, the data processing method comprising:
applying a path metric memory for storing the path metrics, path metric memory comprising memory units of the same amount as the states, the memory units being depicted as the symbol combinations for storing the corresponding path metrics of the set of states; and reading out the path metrics from the path metric memory for the calculation via the Viterbi decoding procedure according to a programmable access control sequence, and writing the updated path metrics back to the path metric memory, the programmable access control sequence comprising a read out sequence and a write back sequence;
wherein the read out sequence sequentially reads out the path metrics from the memory units along a first dimension and obtains a set of updated path metrics via the calculation of the Viterbi decoding procedure, the write back sequence writes the set of updated path metrics back to the same memory units along the first dimension until all the path metrics in the memory units are updated, the read out sequence redirects and reads out the path metrics from the memory units along a second dimension and obtains a set of updated path metrics via the calculation of the Viterbi decoding procedure, the write back sequence sequentially writes the set of updated path metrics back to the same memory units along the second dimension until all the path metrics in the memory units are updated, therefore merely the same amounts of the memory units as the states in the path metric memory are required for update of the set of path metrics.

18. The data processing method of claim 17, wherein the data processing method iteratively reads out the path metrics from the path metric memory and writes the path metrics back to the path metric memory along the first dimension and the second dimension for updating the path metrics in an alternative-odd-and-even way.

19. The data processing method of claim 17, wherein the set of states is encoded by two symbols, each symbol is encoded by 3 bits and comprises 8 possible values for having 64 possible states.

20. The data processing method of claim 17, wherein the set of states is encoded by three symbols, each symbol is encoded by i bits and comprises 2ⁱ possible values for having (2ⁱ)³ possible states, when the read out sequence has completely read out and the write back sequence has written back along the first dimension and the second dimension, the read out sequence sequentially reads out the path metrics of the memory units along a third dimension to obtain a set of updated path metrics via calculation of the Viterbi-encoded procedure, the write back sequence sequentially writes back the set of updated path metrics into the third dimension of the memory until the path metrics of all memory units are updated.
